(19) United States
(12) Patent Application Publication
(10) Pub. No.: US 2016/0283649 A1
(43) Pub. Date: Sep. 29, 2016

(54) Age Authentication For Longer-Lived Vascular Herbal Plants

(71) Applicant: Macau University of Science and Technology, Macau (MO)

(72) Inventors: Chunsong CHENG, MO (MO); Hua ZHOU, MO (MO); Luqi HUANG, Beijing (CN)

(21) Appl. No.: 14/738,944

(22) Filed: Jun. 15, 2015

Related U.S. Application Data
(60) Provisional application No. 62/138,966, filed on Mar. 26, 2015.

(51) Int. Cl. G06F 19/12

(52) U.S. Cl. CPC G06F 19/12

(57) ABSTRACT

The present invention relates to a method for authenticating age of longer-lived vascular plants based on microstructural data obtained either destructively or nondestructively and based on implementation of at least one model to determine growth-year of different cultivars.

### CROSS-REFERENCE TO RELATED APPLICATIONS

The present application claims priority from the U.S. provisional patent application Ser. No. 62/138,966 filed Mar. 26, 2015, and the disclosure of which is incorporated herein by reference in its entirety.

### TECHNICAL FIELD OF INVENTION

The present invention relates to a method for authenticating age of longer-lived vascular plants based on microstructural data obtained either destructively or nondestructively and based on implementation of at least one model to determine growth-year of different cultivars.

### BACKGROUND OF THE INVENTION

Growth-year authentication has extraordinary significance for plant growth and development research, and has important applications in value assessment of economic crops. P. Ginseng is the most commonly used medicinal plant in Asian countries. The fixed number of growth year is an important quality evaluation which is difficult to be obtained accurately in current technical conditions.

Many important plant physiological changes are related to plant age (Thomas, 2011). Particularly important for the accumulation of secondary metabolites, the economic base of medicinal plants. Many natural products rely heavily on the fixed number of growth-year and plant tissues, such as the camptothecin, taxol, ginsenoside et. al. (Cui et. al., 2015; Liu et. al., 1998; Nadeem et. al., 2002; Su et. al., 2004). The current view is that bioactive natural products are the material bases of Chinese Materia Medica resources (Huang et. al., 2014). Therefore, there is a strong relationship between the accumulation of efficacy ingredient and the growth-year in Ginseng (Chen et. al., 2013). For the identification of Chinese Medicines, growth year authentication is an important traditional technique. Moreover, growth-year authentication for ginseng is an important quality-testing project since ancient times. However, age estimation of ginseng is still based on the experience of herbal workers. Throughout the modern age, Recognition usually focuses on forensic science, fish as well as animals' age research and also has been reported in the field of endangered species protection (Yan et al., 2012; Murphy et al., 2012); Whereas, there are few reports in plant research about an estimate method or a model to identify the exact age of plants. Details on the relationship of growth rings and age are rarely discussed in reports. The Radix Saposhnikovia which is cultivated in 1-4 years can be recognized by annual rings of xylem vessel (Feng et al., 2009). Zha's research also showed that age can be identified according to 1-5 years of growth rings within the Paeonia lactiflora Pall. (Zha et al., 2012). It seems that the growth ring is the best way to identify the age of the plants. However, certain vague sections make impossible the identification of the growth rings in the main root of 6 years of ginseng and those even older (Liang et al., 2015). In particular, due to the high price and the collection habits, high growth-year ginseng cannot allow the destruction or disconnection in its root type. Even though the contents of the ginsenoside is argued to have a close relationship with the growth years, Origin, temperature, sunlight, moisture and other factors leading to the accumulation of secondary metabolites, there is not a linear relationship with growth year. A potential method has been recently described that the age of ginseng can be analyzed by telomere length and telomerase activity (TRFs) (Liang et al., 2015). However, it has been found that there are different results in other species and other ginseng cultivars in this research.

To solve the growth-year authentication of vascular plants containing a large number of herbs, there is a need for a new method for micro-analysis of cultivar identification and age authentication without damage under the same mathematical model at the same time in ginseng cultivars.

Previous studies have reported a mathematical model for identifying the growth year of a vascular plant (Cheng et al., 2012). It suggested that microscope is one of the most efficient and effective tools which enables us to find a reliable way to identify the plant “bone age”. In fact, to establish the age identification model, it requires a lot of microstructure data of one sheer plant species, considering that the P. ginseng contains more than 10 cultivars. Therefore, cultivar authentication and growth year authentication using the same theoretical system as in P. ginseng will be discussed in examples to illustrate how the present invention can authenticate age of vascular plants including ginseng.

### SUMMARY OF INVENTION

Accordingly, the main objective of the present invention is to estimate the growth-year in longer-lived vascular plants, e.g., ginseng cultivars, and in order to do so, an age authentication method for longer-lived vascular plants is herein provided. The age authentication method of the present invention comprises providing micro data which have a series of gradient ages. In one embodiment, the micro data can be obtained from 204 individuals in three different kinds of ginseng cultivars. In another embodiment, the micro data comprise outer diameter of the vascular cambium (b) and the radius of cross section (r) which can be measured with an ordinary stereo microscope. The age authentication method of the present invention further comprises providing two authentication models for growth-year authentication (P=β*M^{-α} and M=K*X₁^{a1}X₂^{a2}) and using thereof to determine and identify the age of vascular plants. In an embodiment, the models are applied to identify the growth-year of ginseng without damage comprising using Micro-CT or DEI reconstruction. As a comparative study, telomere length and telomerase activity of different samples are also obtained and the result thereof are analyzed to compare with the result obtained in other species. After all, it is concluded that said microscopic methods for obtaining the microstructural data provide more value in growth-year authentication than the telomeric terminal restriction fragment measurement against age.

The present method can be destructive or nondestructive depending on how to obtain the microstrutural data. For the destructive method of the present invention, hand sliced or paraffin sliced taproot can be analyzed under an ordinary microscope with a millimeter ruler. Paraffin slice method is one of the examples, where samples are sliced into many pieces by conventional slicer. The complete pieces are screened for microscopic measurement, permeated with the chloral hydrate, and the average values of four measurements in different directions are used to obtain the values of section radius “r” and cambium radius “b” in order to determine sectional area and cambium area of the taproot section of the vascular plants. For the nondestructive method, micro-CT using X-ray are used as an alternative method for nondestructive measurement of the microstructual data.

The present method incorporates using corresponding mathematical model which is found under the microscopy based on the allometric differentiation, and it is another form of differentiation law and found in the vascular plant roots for the first time. Different vascular plant, especially ginseng, cultivation have different differentiation law and are expressed by different mathematical models and empirical formulas in the present invention. Different ginseng cultivars can be determined by a large number of samples of exact age using the 3-D mathematical models of the present invention, where the fix number of growth year for a known cultivar can be determined. Both models are based on the same principles provided in the present invention.

### BRIEF DESCRIPTION OF DRAWINGS

Embodiments of the present invention are described in more detail hereinafter with reference to the drawings, in which:

FIG. 1 is a schematic diagram showing standard sampling location of a ginseng sample in different views based on the method of the present invention; on left hand side: taproot view; on right hand side: a cross-sectional view.

FIG. 2 is a series of plot based on the following respective regression equations showing the relationship between the proportion of cambium area and sectional area (P) and age (n) of each ginseng cultivar; (A): Ji'an Ermaya-ginseng, the function of P and n is y=0.0169x-0.657, r²=0.9563; (B): Fusong Ermaya-ginseng, the function of P and n is y=0.157x-0.682, r²=0.9638; (C): Fusong Damaya-ginseng, the function of P and n is y=0.0152x-0.763, r²=0.908; (D): Shizhu-ginseng, the function of P and n is y=0.0205x-0.467, r²=0.8701.

FIG. 3 is a series of plot based on the functional equations showing the relationship between the area of phloem/xylem and the growth year in different ginseng cultivars: (A) Allometric law exists between the area of xylem and the growth year; (B) Allometric law exists between the area of phloem and the growth year.

FIG. 4 shows a 3-D curved surface mathematical model for four kinds of ginseng (Fusong Damaya, Fusong Eamaya, Shizhu-ginseng, and Ji'an Ermaya). As the growth of the age, xylem and phloem showed different trends in the taproot of four kinds of Ginseng.

FIG. 5 shows quantification of the growth completion of different ginseng cultivars. Relative growth rate of xylem of different cultivars is expressed as

$$\frac{Δ b}{Δ r} ,$$

which represents the taproot growth in single cultivar. *, p<0.05; and **, p<0.01 by ANOVA followed by multiple comparison with SNK method. (n=10˜40).

FIG. 6 shows the result of telomeric terminal restriction fragment (TRF) measurement in P. lactiflora and P. ginseng, ANOVA: (A) 1˜14 years old SHIZHU ginseng, F=3.651 P=0.002<0.01 (n=6); (B) 1˜5 years old P. lactiflora, F=64.485 P=4.896*10̂−9<0.01 (n=6).

FIG. 7 shows age estimation by micro-CT (X-ray) using SHIZHU ginseng as an example: a taproot terminal of Shizhu-ginseng, after micro-CT, is obtained with the microstructural data of r=9.75 mm, b=6.90 mm (Take the average of several measurements); Bar=10.00 mm.

### DETAILED DESCRIPTION OF THE INVENTION

The following description and the corresponding embodiments of the present invention are set forth as preferred examples. It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

### 1. MATERIALS AND METHODS

1.1 Sample Collection

Different cultivars of ginseng were collected respectively in October 2011 and August 2012. Because of the precious resource and the top-down sheet agricultural base, Line transect method (Buckland et al., 2007) was used in the present invention. It is found that there are three cultivars which can reflect the different root-types of ginseng in three regions of Northeast China shown in table 1.

TABLE 1
Different Ginseng Cultivars collected in northeast China's Jilin
and Liaoning:

| | Collection | Collection | | |
|---|---|---|---|---|
| Cultivars | Address | Date | Surveyor | Samples Overview |
| Damaya | WanLiang town | 2012 Aug. 1 | SAP-CCAS | 1~7 years, 6 for each |
| Ermaya | WanLiang town | 2012 Aug. 2 | SAP-CCAS | 1~5 years, 6 for each |
| Ermaya | Ji'an city | 2012 Aug. 4 | SAP-CCAS | 1~8 years, 6 for each |
| Shizhu | Kuandian town | 2011 Aug. 6 | SAP-CCAS | 1~14 years, 6 for each |
| Shizhu | Kuandian town | 2011 Oct. 21 | SAP-CCAS | 1~14 years, 3 for each |
| P. lactiflora | Siping city | 2011 Oct. 10 | — | 1~6 years, 6 for each |

NOTE:
SAP-CCAS: Institute of Special Animal and Plant Science of Chinese Academy of Agricultural Sciences.

1.2 Microscopic Measurement and Model Building

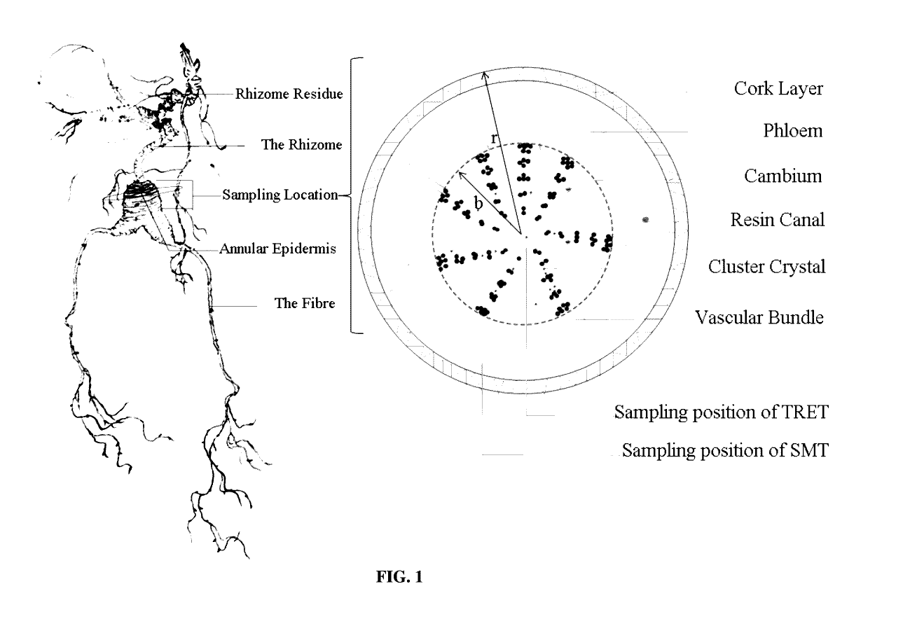

FIG. 1 is a schematic diagram of the location of sampling in ginseng samples including a Taproot view (left hand side) and a cross-sectional view (right hand side). First of all, taproot section is measured by microscopy. Then, the centre of the cross section is used for telomeric terminal restriction fragment (TRF) measurement. Taproot view is drawn according to traditional Chinese medicine graphics which includes most of the characters and features of ginseng, and is referenced to the “Wild ginseng character identification technology” (Shifu Fang, 2010.); the cross-sectional view is drawn according to the plant microscopic graphics.

The samples are cut into small sections of 10 mm, and kept in formalin-acetic acid (FAA) solution for more than 24 hours. The target site is labeled as “sampling location” as shown in the FIG. 1, and the portion belonging to “sampling location” is sliced into many pieces by Leica Weaving Slicer. The sliced pieces are screened for microscopic measurement, followed by permeated with the chloral hydrate, and the average values of four measurements in different directions were processes used to obtain the values of “r” and “b” shown in the FIG. 1. (Cheng et al., 2013). Cambium lived as a banding between the primary xylem and phloem which are made up by smaller cells of 2˜3 layers (Banan, 1968). The reports of the microscopic structure of the vascular cambium cell showed that it is constituted by a fusiform initial and ray initial, and there is a larger nucleus in the cell (Buvat, 1955). The model is based on the prompts of the experiences and findings of telomerase research, described in the previous report, and in which initial theories of plant growth year's authentication were discussed (Cheng et al., 2013).

1.3 Telomere Length Analyses

Reference to the reported method (Kimura et al., 2010), as a target in the centre of xylem which is labeled as “sampling position of TRF” as shown in the FIG. 1. Three separate fresh ginsengs are crushed with liquid nitrogen and used for DNA extraction using the method of cetyltrimethylammonium. (Shepherd et al., 2011). DNA (5˜10 ug) is digested by Ex-Taq (New England Biolabs (Beijing) LTD. NEB) overnight and fragments are separated by electrophoresis at 60V constant voltage for 4˜5 hours using 0.95% agarose-gel. The telomere length is measured by southern blot analysis of terminal restriction fragment lengths (Masayuki et al., 2010). The Roche hybrid kit is used in washing nylon membrane, closing and photographing development. For the second procedure, the TRF average length is calculated by Telometric 1.2 with the following formula:

$$T R F = \frac{\sum Ai}{\sum ( \frac{Ai}{Li} )} ,$$

where Ai stands for the absorbance value, Li stands for the Marker length of the calculation object.

1.4 Age Estimation by Micro-CT (X-Ray)

The ginseng samples from different cultivars are dried under reduced pressure at −20° C., over 24 h., and stored in a dry vessel, until machine testing. Small-angle scattering (SAXS) is used to obtain the projection and background images. The objects are rotated 360 degrees and projection data are obtained at the waist in the Institute of High Energy Physics Research (HEPR), Chinese Academy of Sciences. Section and three-dimensional images are reconstructed by DEI Reconstructor V3.6 which is developed by HEPR.

### 2. RESULTS

2.1 Age Estimation Based on Allometric

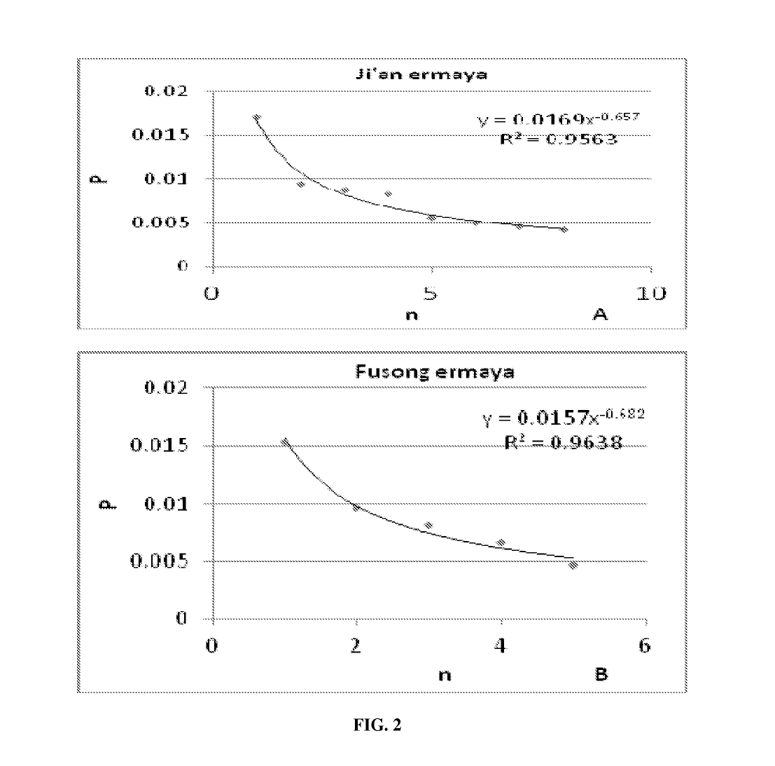

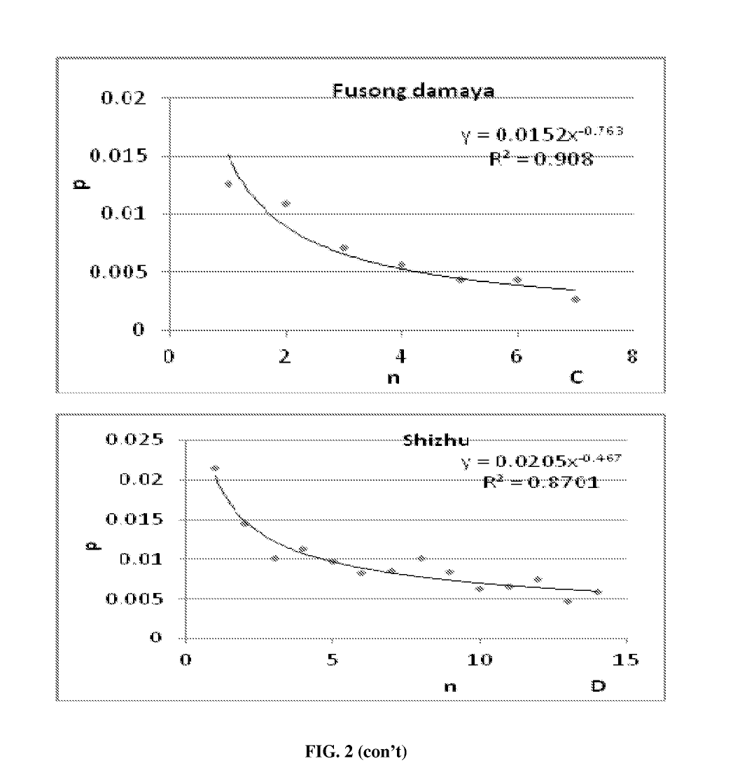

It is found that the proportion of cambium cells decreased with the age from telomerase research (Cheng et al., 2012). According to previous studies of relational expression:

$$P = Scambium / S cross \text{-} sectional = \frac{{π ( b )}^{3} - {π ( b - 0.04 )}^{2}}{{π ( r )}^{2}} = \frac{0.08 \times ( {b}_{n} - 0.02 )}{{r}_{n}^{2}} = β * {X}^{- α} ( n = 1 , 2 , 3 … )$$

where P: the proportion of cambium area and sectional area; n: the age; r: Section radius; b: Radius of cambium; X: the harvest age; β: coefficient; α: index, and whereby, in the regression equation, the proportion of cambium cells decreases with age, and three kinds of cultivated ginseng are collected from three different origins. Different regression equations are shown in FIG. 2. The respective regression equation about the proportion Y and harvest age X for each of the cultivars is as follows: Y=0.0169X^{-0.657} is obtained to estimate the age of Ji'an Ermaya ginseng (FIG. 2A); Y=0.0157X^{-0.682} is obtained to estimate the age of Fusong Ermaya ginseng (FIG. 2B); Y=0.0152X^{-0.763} is obtained to estimate the age of Fusong damaya ginseng (FIG. 2C); Y=0.0205X^{-0.467} is obtained to estimate the age of Shizhu-ginseng (FIG. 2D).

2.2 3-D Growth Model of Ginseng

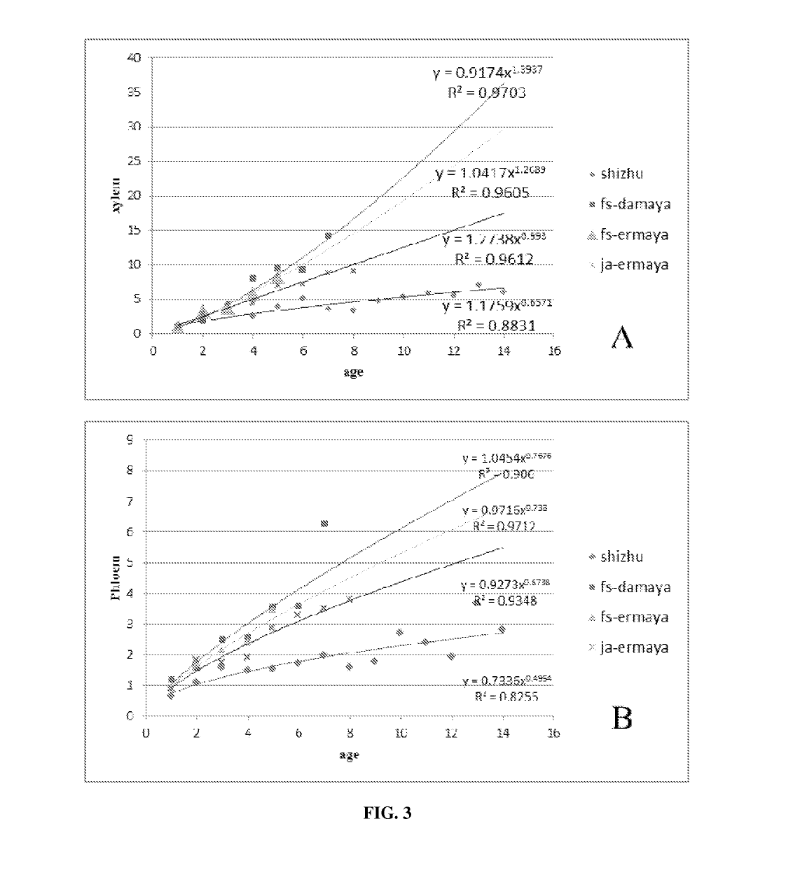

Allometric law also exists between the area of phloem and xylem and the growth year in different ginseng cultivates shown in FIG. 3.

Plant age and the mass of xylem and phloem growth are also subjects in the allometric law. Simulated three-dimensional curved surface equation is based on the xylem and phloem radial data of ginseng in different ages.

The dependence of a biological variable Y on body mass M is typically characterized by an allometric scaling law of the form:

Y=Y₀M^{b} (1)

Then the functional relationship, growth years (Y) and the area of phloem (X₁) and xylem (X₂) are described as follows:

Y=a₁*X₁^{b1} (2)

Y=a₂*X₂^{b2} (3) (a1, a2 are coefficients)

Y=\sqrt{a1a2*X1^{b1}X2^{b2}} (2)*(3)

Rewritten to power functions in the following type:

Y=K*X₁^{M}X₂^{N} (4) (K is a coefficient)

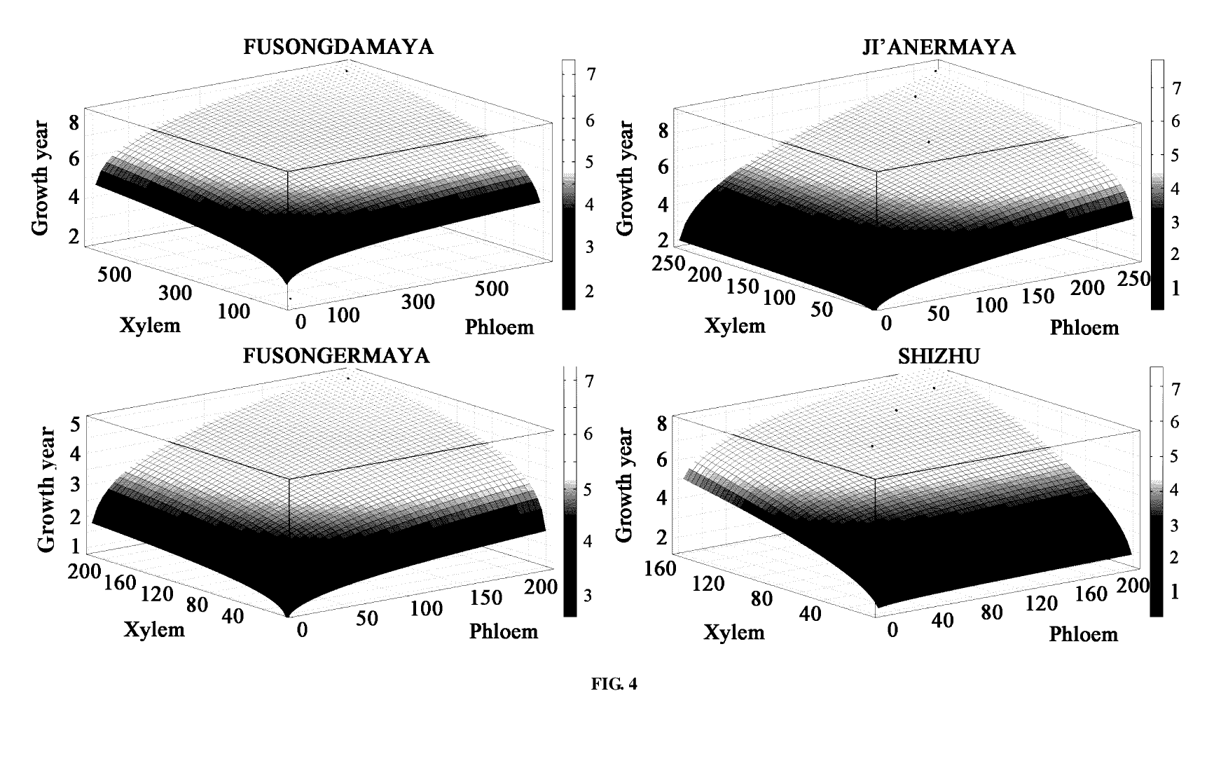

Matlab 7.0 is used to create the 3-D curved surface mathematical model, and the results are shown in Table 2. And the 3-D curved surface Mesh shown in FIG. 4.

TABLE 2
The 3-D curved surface mathematical model for
estimate the age of the different Cultivars of ginseng:

| Cultivars | Surface Equation | R² |
|---|---|---|
| Fusong Damaya | Y = 0.6634X₁^{0.1665}X₂^{0.2012} | 0.9593 |
| Fusong Ermaya | Y = 0.4731 X₁^{0.2498} X₂^{0.1949} | 0.9664 |
| Ji'an Ermaya | Y = 0.2614 X₁^{0.4067} X₂^{0.1998} | 0.9959 |
| Shizhu | Y = 0.5084 X₁^{0.1661} X₂^{0.4898} | 0.9696 |

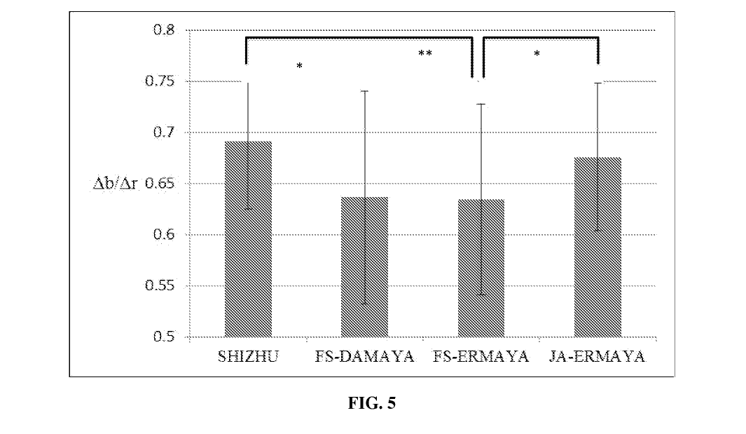

According to the value of R², the 3-D curved surface mathematical model may be more accurate for age authentication. Different traits of different varieties and origins can be grasped easily from the type of the 3-D curved surface Mesh shown in FIG. 4. There is different growth completion in different cultivars showing in FIG. 5. Relative growth rate of xylem of different cultivars, which is expressed as

$$\frac{Δ b}{Δ r} ,$$

shows that phloem and xylem growth are relatively uniform in different cultivars of DAMAYA and ERMAYA which were produced in FUSONG in Northeast China's Jilin province; in contrast, there is an obviously different growth rate with the same cultivar of ERMAYA which were produced in different origins FUSONG and JI'AN in Northeast China's Jilin province.

If the phloem area is larger than xylem area:

$$π {r}^{2} - π {b}^{2} > π {b}^{2} , \\ then , \\ \frac{Δ b}{Δ r} < 0.7071$$

So, as show in FIG. 5, it illustrated that the growth rate of phloem is lower than the xylem in all cultivars, and the significant results shown in FUSONG cultivars. In addition, the established models are constructed with a large amount of microscopy data, cultivar identification becomes possible using the same mathematical model. However, due to the large individual differences in the same cultivar, it is very important to obtain a wide range of samples in different growth-year for detection accuracy.

2.3 TRF Measurement in P. lactiflora and P. ginseng

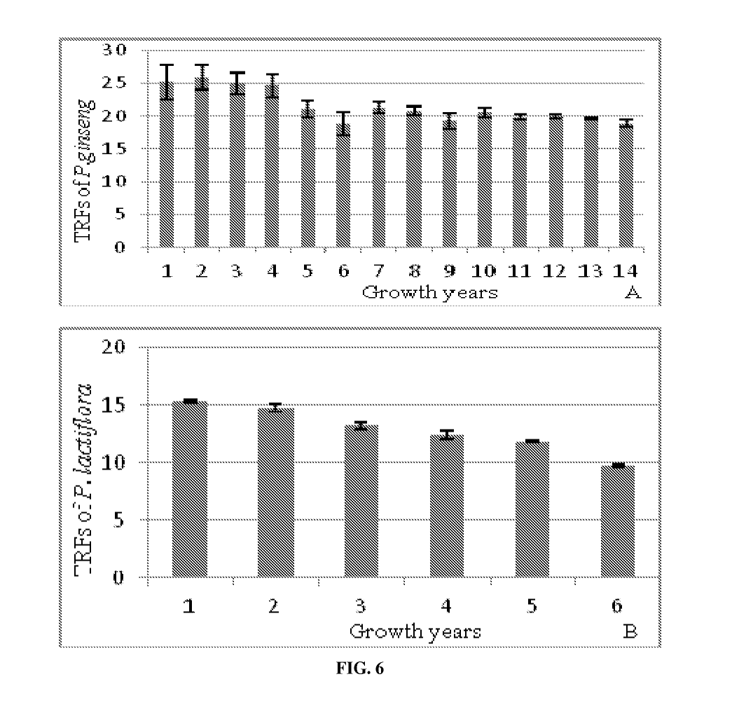

The average telomeric terminal restriction fragment (TRF) analysis can be applied to plant age because it is a mature and recognized method to obtain telomere length parameters by southern blots of TRFs in other species (Kimura et. al., 2010). Two kinds of plant are chosen in the present invention for TRF analysis: one longer-lived and one shorter-lived, which are P. ginseng and P. lactiflora (Cultivar of SHIZHU), respectively. According to the previous findings of telomerase test (Cheng et. al., 2013), a special sampling site is considered to be the most representative of age shown in FIG. 1, which is the xylem centre in taproot, 1˜2 cm from the reed head. The results are shown in FIG. 6. The results show that the average TRF decreases with an increase in age in P. lactiflora; there is no clear linear relationship between average TRF and age in P. ginseng (Cultivars of SHIZHU).

It is known in the art that the age can be easily identified by bone age (Walters, 2012). The same strategy has been used in the plant age identification, the annual ring or growth ring. It could also be useful for millennium trees. However, it is eclipsed long-lived herb, e.g., ginseng. Because trees and animals share similarities, and the age can be determined by the genetic material, there are different mechanisms of the age-increasing in different species (Watson et. al., 2011). Both in animals or at cellular level, many reports have provided that the biological age can be estimated based on the telomere shortening (Chen et al., 2011; Watson et. al., 2011). A recent study showed that TRFs of JI'AN ginseng increases with age, which was tested with 6 stages (Liang et al., 2015). In the above example of the present invention, however, it shows that TRF decreases with age in SHIZHU ginseng, and there is no significant linear relationship exists in the stages of age but only a significant shortening in P. lactiflora. Thus, great difference exists in different species and cultivars when identification of plants' age relies on the TRF measurement. Therefore, specific sampling points ensure the TRF shortening trend, but no significant linear relationship exists to build any mathematical models in the present invention.

2.4 Growth Year Authentication without Damage Using Micro-CT and DEI Reconstruction

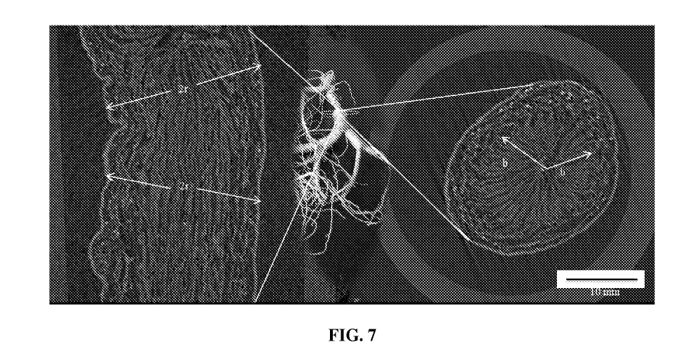

Nondestructive method is realized based on DEI Reconstruction or Micro-CT. It proved that the empirical formula can be used in ginseng age estimates. For example, in FIG. 7. One taproot of Shizhu-ginseng, after micro-CT, is obtained with the microstructural data of r=9.75 mm, b=6.90 mm, A clear cross-sectional view is shown in FIG. 1. Referencing to the formula

$$P = \frac{0.08 \times ( {b}_{n} - 0.02 )}{{r}_{n}^{2}} = 0.0205 {X}^{- 0.467} ,$$

the harvest years X=13.49 can be identified; Referencing to the formula Y=K*X₁^{M}X₂^{N}, the harvest years Y=13.49 can also be identified. These results show that the age can be realized without damage by X-ray using the two mathematical models provided in the present invention.

### 3. DISCUSSIONS

As a result, microscopy is more superior to molecular recognition for the age estimate in vascular plants. It can easily identify ginseng's age by two kinds of mathematical models. However, the establishment of microscopic identification method is based on the complex distribution of the telomerase in the main root section (Cheng et al. 2013). This is an important theoretical evidence to prove the reasonableness of the mathematical model. In spite of the fact that the models can be used to identify growth-years of ginseng, the high growth-years of samples, which are over 40 years old or even 100-150 years old, are very scarce. Therefore, conventional models have not yet been rigorously corrected for old-wild-ginseng, and the universal principles about age authentication in vascular plants cannot be summarized according to these models. Perhaps study of more samples including herbs of high age will make us find “bone age” in vascular plants. Even so, the microscopic analysis proves engaging and useful. In particular, a method for plant species identification and age authentication without damage under the same mathematical model at the same time comprising using the 3-D curved surface mathematical model and the curved surface Mesh is provided in the present invention.

### INDUSTRIAL APPLICABILITY

Growth-year authentication has extraordinary significance for plant growth and development research, and has important applications in value assessment of economic crops. In the present invention, a systematic method of the growth-year identification theory of ginseng is provided. This is a great deal of progress in material selection for plant research and a key progress for the orientation of breeding based on the root type in ginseng cultivars. In particular, patterns in the taproot structure will create growth and development of visualization; mathematical model based on the taproot structure development is a great deal of progress in ginseng industry, which makes the age identified without damage using X-ray Micro-CT, and meets the traditional experience; 3-D mathematical model can identify the growth-year under microscopy, as well as identify different cultivars in the same time, this will save a huge research resources and reduce testing costs. Moreover, the result of molecular techniques (TRFs) using different plant species in the present invention proves that the microanalysis based on microscopy is more reliable in growth-year authentication. Thereby, “Bone age” of plant will become an important medium for plant growth and structure.

### REFERENCES

Thomas, S. C. (2011). Age-related changes in tree growth and functional biology: the role of reproduction. In Size-and age-related changes in tree structure and function (pp. 33-64). Springer Netherlands Press.
Banan M W. 1968. Anticlinal divisions and organization of conifer cambium. Bot Gaz, 33(1):78-81.
Buckland, S. T., Borchers, D. L, Johnston, A.; Henrys, P. A. Marques, T. A. (2007). Line Transect Methods for Plant Surveys. Biometrics. 63 (4):989-998.
Buvat R. Le. (1955). Méristème apical de la tige. Ann Biol, 31:595-656.
Chen, F., Luo, J., & Kong, L. (2013). Determination of 10 ginsenosides in Panax ginseng of different harvest times based on HPLC fingerprints and principal component analysis. Natural product research, 27(9), 851-854.
Chunsong Cheng, Daiyin Peng, Luqi Huang, Xiaohui Ma. (2013). Years-identification mathematical model of paeonia lactiflora pall. based on the allometric-scaling. Microscopy Research and Technique. 76:201-208.
CU ILi-li, PANGShi-feng, WANG Ying-ping, ZHAO Jing-hui, YAO Chun-lin. (2013). Comparative Study on the Content of Ginsenosides in Wild Ginseng of Different Origins and Growth Years in Jilin Province. Journal of Jilin Agricultural University. 1-6.
Cui, S., Wang, J., Yang, L., Wu, J., & Wang, X. (2015). Qualitative and quantitative analysis on aroma characteristics of ginseng at different ages using E-nose and GC-MS combined with chemometrics. Journal of pharmaceutical and biomedical analysis, 102, 64-77.
Feng, X., Fu, G., Ge, X., Yang, J., & Xue, H. (2009). Difference of shapes and properties and microscopic frameworks between wild and cultivated Radix Saposhnikovia. China journal of Chinese materia medica, 34(22), 2862-2866.
Huang, L. Q., Gao, W., & Zhou, Y. J. (2014). Application of synthetic biology to sustainable utilization of Chinese materia medica resources. Acta pharmaceutica Sinica, 49(1), 37-43.
J. Mathew Watson and Karel Riha. (2011). Telomeres, Aging, and Plants: From Weeds to Methuselah A Mini-Review. Gerontology. 57:129-136.
Jiao, Y., Smith, E. P., O'Reilly, R., & Orth, D. J. (2012). Modelling non-stationary natural mortality in catch-at-age models. ICES Journal of Marine Science: Journal du Conseil, 69(1), 105-118.
Kimura, M., Stone, R. C., Hunt, S. C., Skurnick, J., Lu, X., Cao, X., Harley, C. B. and Aviv, A. (2010). Measurement of telomere length by the southern blot analysis of the terminal restriction fragment lengths. Nat. Protoc., 5, 1596-1607.
Kimura, M., Stone, R. C., Hunt, S. C., Skurnick, J., Lu, X., Cao, X., Harley, C. B. and Aviv, A. (2010). Measurement of telomere length by the southern blot analysis of the terminal restriction fragment lengths. Nat. Protoc., 5, 1596-1607.
LI Xiang-guo, QUAN Bing-wu, LI Hu-lin, PIAO Ren-zhe, JIN Da-yong. (2012). Research progress in variation of ginsenoside. Chinese Traditional and Herbal Drugs. 43(11):2300-2304.
Liu, Z., Carpenter, S. B., Bourgeois, W. J., Yu, Y., Constantin, R. J., Falcon, M. J., & Adams, J. C. (1998). Variations in the secondary metabolite camptothecin in relation to tissue age and season in Camptotheca acuminata. Tree Physiology, 18(4), 265-270.
Masayuki Kimura, Rivka C Stone, Steven C Hunt, Joan Skurnick, Xiaobin Lu, Xiaojian Cao, Calvin B Harley, Abraham Aviv. (2010). Measurement of telomere length by the Southern blot analysis of terminal restriction fragment lengths. Nature Protocols. 5(9):1596-1607.
Murphy, S., Spradlin, T. R., Mackey, B., McVee, J., Androukaki, E., Tounta, E. & Matthiopoulos, J. (2012). Age estimation, growth and age-related mortality of Mediterranean monk seals Monachus monachus. Endangered Species Research, 16(2), 149-163.
Nadeem, M., Rikhari, H. C., Kumar, A., Palni, L. M. S., & Nandi, S. K. (2002). Taxol content in the bark of Himalayan Yew in relation to tree age and sex. Phytochemistry, 60(6), 627-631.
Su, J., Zhang, Z., & Deng, J. (2004). Study on the taxol content in Taxus yunnanensis of different age and different provenance. Forest Research, 18(4), 369-374.
Taik-Koo Yun. (2003). Experimental and epidemiological evidence on non-organ specific cancer preventive effect of Korean ginseng and identification of active compounds. Mutation Research. 67-74.
W. Chen, M. Kimura, S. Kim, X. Cao, S. R. Srinivasan, G. S. Berenson, J. D. Kark, A. Aviv. (2011). Longitudinal versus Cross-sectional Evaluations of Leukocyte Telomere Length Dynamics: Age-Dependent Telomere Shortening is the Rule. The Journals of Gerontology: Series A. 66(3): 312-319.
Walters T D. (2012). IBD: Is measuring bone age in children with Crohn's disease useful. Nat Rev Gastroenterol Hepatol. 9(11): 620-622.
Zha, L. P., Cheng, M. E., & Peng, H. S. (2012). Identification of ages and determination of paeoniflorin in roots of Paeonia lactiflora Pall. From four producing areas based on growth rings. Microscopy research and technique, 75(9), 1191-1196.

What is claimed is:

1. A method of authenticating cultivar and age of longer-lived vascular plants comprising:
a) providing microstructural data of a taproot section of the vascular plants;
b) providing at least one model for the age authentication;
c) using the same model in step (b) to authenticate cultivar based on proportion of growth rates of xylem and phloem of the vascular plants.

2. The method of claim 1, wherein said method is either destructive or nondestructive,
wherein when the method is destructive, the microstructural data in step (a) is obtained by hand sliced or paraffin sliced to measure section radius and cambium radius in order to determine sectional area and cambium area of the taproot section of the vascular plants; or
when the method is nondestructive, the microstructural data in step (a) is obtained by micro-CT or DEI reconstruction to measure section radius and cambium radius in order to determine sectional area and cambium area of the taproot section of the vascular plants.

3. The method of claim 1, wherein said at least one model for the age authentication comprises using the following formula:
$$P = \frac{0.08 \times {Yb}_{n} - 0.02 Y}{{r}_{n}^{2}} = β * {X}^{- α} ,$$
where P is proportion of the cambium area and sectional area; n is the age; r is the section radius; b is cambium radius; X is harvest age; β: coefficient; α: index, and
wherein said longer-lived vascular plants are different cultivars of ginseng and the section or cambium radius is measured from xylem centre of the taproot section which is about 1˜2 cm from reed head of the ginseng.

4. The method of claim 1, wherein said at least one model for the age authentication comprises the following formula:
Y=K*X₁^{M}X₂^{N} or Y=\sqrt{a1a2*X1^{b1}X2^{b2}},
where Y is growth year; X₁ is area of phloem; X₂ is area of xylem; K is a coefficient; a1 and a2 are coefficients, and
wherein said longer-lived vascular plants are different cultivars of ginseng.

5. The method of claim 3, wherein said formula is used to obtain different regression equations for authenticating age of different cultivars of ginseng, said regression equations comprising:
a) Y=0.0169X^{-0.657} for authenticating age of Ji'an Ermaya ginseng;
b) Y=0.0157X^{-0.682} for authenticating age of Fusong Ermaya ginseng;
c) Y=0.0152X^{-0.763} for authenticating age of Fusong Damaya ginseng;
d) Y=0.0205X^{-0.467} for authenticating age of Shizhu-ginseng.

6. The method of claim 4, wherein said formula is used to obtain different regression equations for authenticating age of different cultivars of ginseng, said regression equations comprising:
a) Y=0.6634X₁^{0.1665}X₂^{0.2012} for Fusong Damaya with R² of 0.9593;
b) Y=0.4731X₁^{0.2498}X₂^{0.1949} for Fusong Ermaya with R² of 09664;
c) Y=0.2614X₁^{0.4967}X₂^{0.1998} for Ji'an Ermaya with R² of 0.9959;
d) Y=0.5084X₁^{0.1661}X₂^{0.4898} for Shizhu-ginseng with R² of 0.9696.

7. The method of claim 1, wherein said proportion of growth rates of xylem and phloem of the longer-lived vascular plants is represented by
$$\frac{Δ b}{Δ r}$$
to authenticate different cultivars of the vascular plants, wherein the longer-lived vascular plants are ginseng and the growth rates of the xylem and phloem are expressed in terms of the areas of xylem and phloem respectively, or expressed as πr² and πb², where r is the section radius while b is cambium radius measured from xylem centre of the taproot section which is about 1˜2 cm from reed head of the ginseng, and
wherein if the phloem area is larger than xylem area, then πr²−πb²>πb², or vice versa, and
wherein each cultivar of the ginseng has a specific
$$\frac{Δ b}{Δ r}$$
which can be used as a reference for authenticating the cultivar of an unknown ginseng sample.
